(19) United States
(12) Patent Application Publication
(10) Pub. No.: US 2007/0113450 A1
(43) Pub. Date: May 24, 2007

(54) Human-shaped portable, moving support stand for advertising signs

(76) Inventors: Cathy D. Santa Cruz, Reno, NV (US); Robert R. Cotter, Sparks, NV (US)

Correspondence Address: Cathy D. Santa Cruz, 7630 Tholl Drive, Reno, NV, 89506, US

(21) Appl. No.: 11/250,916

(22) Filed: Oct. 14, 2005

(51) Int. Cl. G09F 15/00

(52) U.S. Cl. 40/608

(57) ABSTRACT

A novel support stand used for support of an advertising sign thereon. The support stand being made from a “stick framework” arranged to resemble a human form with the framework being removably, adjustably interconnected together. The framework includes an upper body portion and a lower body portion. Each being removably adjustably attached together by a flexible device and the flexible device flexes when subjected to air turbulence caused by wind resulting in movement of the framework.

### FIELD OF THE INVENTION

The present invention relates in general to support stands used for advertising signs but more particularly pertains to such support stands that are in the shape of a human form “stick framework” and are portable. More importantly the support stand automatically moves as a result from wind so as to be “distracting” and “attract visual attention” to the sign from passer-bys, motorists, pedestrians, etc.

### BACKGROUND OF THE INVENTION

It is well known that businesses and the like normally provide some type of advertising display sign so as to notify passer-bys, motorists and/or pedestrians where the business is located and also as to what type of business services they provide. In most situations such business signs are usually presented and displayed externally onto the building itself and/or posted onto a display board located in close proximity thereto. These types of display signs are functional for their intended use but they do not satisfactorily attract attention by visual distraction and this tends to be much more desirable, effective and advantageous.

As a result, (being that a moving sign is much more effective) many businesses hire people to hold and move signs and walk about so as to be distracting and attract visual attention. It has proven that this type of advertising is extremely effective and thus businesses don't mind paying the extra fee's associated with hiring a person specifically for this purpose. However, people not only must be paid for this service but they also need to take breaks and normally only work 8-hour shifts. Therefore during the break time no advertising is incurred unless extra break people are hired. Furthermore as a result, normally such employees only work during the day shift and thus swing and graveyard shifts do not have sufficient advertising. A further disadvantage of hiring personnel for this type of advertising is that it can be dangerous. Most often the advertising employee is subjected to heavy traffic flow and can easily become the target in an accident. This is another disadvantage as additional medical costs for the employer may be resultant.

Some of the noted disadvantages and drawbacks have been recognized and somewhat addressed within U.S. Pat. No. 5,001,475 entitled “PORTABLE TRAFFIC CONTROL DEVICE”. Wherein taught is a portable ground-supported automobile traffic control device including an upright, double-sided human-shaped figure which is so constructed and configured as to simulate a traffic control officer, and having one arm and hand in a raised position and carrying thereon, back-to-back electrical stop-and-go traffic light signal units. The traffic light signal units face in opposite directions, and are powered by storage batteries in a base that is provided for the figure. An automatic controller is connected to the signal units and to the batteries, resulting in synchronized stop, stop-and-go, or other displays on the traffic light signal units, thereby to provide visual directions to motorists for the orderly control of two-way traffic in the vicinity of the figure. This device is functional for its intended use but it is not functional for advertising. The device is simply a portable traffic sign, is battery powered and very complicated using numerous electronics with associated parts. More importantly the device does not move in any manner and is thus not as effective as a real human being. It is recognized that the main purpose of this type of device and associated prior art, is to provide a traffic control means that eliminates the need for a traffic control officer so as to reduce accidents often incurred therewith.

### OBJECTS AND ADVANTAGES OF THE PRESENT INVENTION

It is therefore a primary object of the present invention to provide a new and improved advertising display apparatus that is most effective as it not only resembles a human being such as in the form of a “stick framework”. However, more importantly automatically moves as a result from wind so as to be distracting and attract attention.

Another object of the present invention is to provide a new and improved advertising display apparatus that is most cost effective as it eliminates the need for additional employees.

Yet another object of the present invention is to provide a new and improved advertising display apparatus that is portable and easily assembled/disassembled at the point of use.

Still a further object of the present invention is to provide a new and improved advertising display apparatus that is cost effective to manufacture and produce.

Also another object of the present invention is to provide a new and improved advertising display apparatus that is novel, comical, amusing and pleasing to the eye.

A most important object of the present invention is to provide a new and improved advertising display apparatus that is of simple construction and eliminates the need for costly complicated components such as associated within the known prior art.

Yet a further object of the present invention is to provide a new and improved advertising display apparatus that is safe to use and eliminates any medical costs related to accidents associated with an employee performing the same service.

A very important object of the present invention is to provide a new and improved advertising display apparatus that is functional 24 hours a day. It is to be noted for more visual effects during the nighttime hours the display apparatus and/or the sign itself may be made from fluorescent material so as to glow in the dark, which is most advantageous and very effective.

Also another object of the present invention is to provide a new and improved advertising display apparatus that is automatically actuated by air turbulence from wind caused or created by passing vehicles and the like.

Other objects and advantages will be seen when taken into consideration with the following specification and drawings.

### BRIEF DESCRIPTION OF THE DRAWINGS

FIG. 1 is substantially an overview of the construction and assembly of the preferred embodiment for the present invention.

FIG. 2 is substantially a partial enlarged side view depicting attachment means for attaching a sign onto the framework

FIG. 3 is substantially a partial enlarged side view depicting an optional adjustable attachment means for attaching a sign onto the framework.

### DETAILED DESCRIPTION OF THE DRAWINGS

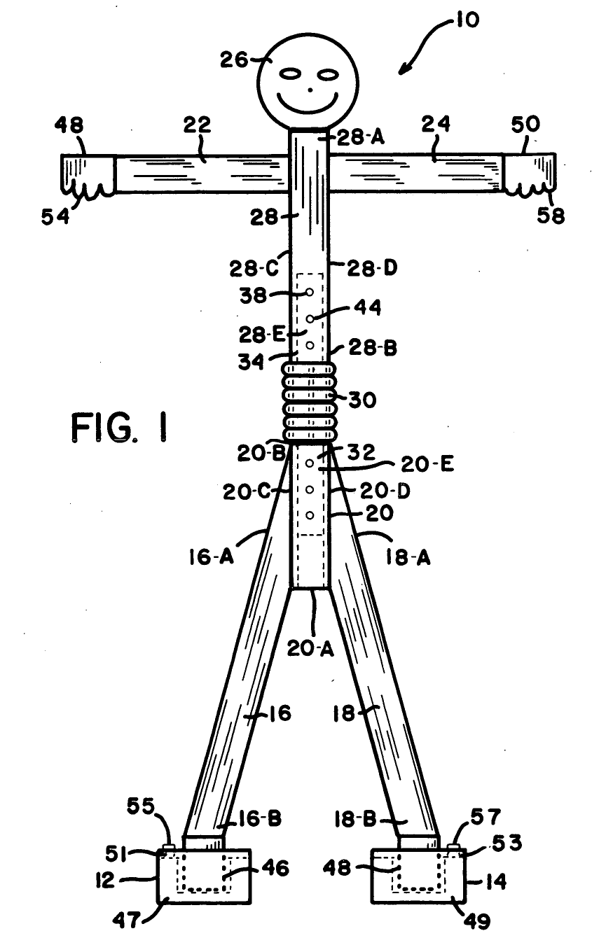

Referring now in detail to the drawings wherein like characters refer to like elements throughout the various views. Within FIG. 1, (10) is substantially an overview of the preferred embodiment for the present invention. It is to be noted there are numerous configurations for assembly of the invention, thus the following description is to be exemplary of one embodiment but the invention is not to be limited thereto.

The general overview (10) depicts a human shaped portable, moving support stand for display of an advertising sign. The support stand can be made from any suitable type of material of engineering choice, such as aluminum, wood, plastic, hard rubber or the like. However as depicted herein the preferred material of choice is hollow steel square tubing. The overall general concept of the invention is to teach a support stand that provides in combination a stick framework which when assembled resembles a human form, respectively. The framework includes attachment means for removably attaching a display sign thereon, support means for supporting the stick framework in an upright standing position, and a flexible device that automatically flexes when subjected to air turbulence caused by wind, thus resulting in movement of the stick framework. The particulars of construction, assembly and suitable components are as follows.

As taught and depicted herein, the framework is formed from body members that are removably attached together. The body members including a first foot member (12), a second foot member (14), a lower body member and an upper body member, and each foot member (12 & 14) in combination provide the noted support means.

As can be seen in FIG. 1, the first foot member (12) includes attachment means (later described) for removably attaching the first foot member (12) onto the lower body member. The second foot member (14) includes attachment means (later described) for removably attaching the second foot member (14) onto the lower body member. The lower body member and the upper body member are removably attached together by the noted flexible device, (later described).

The lower body member includes a first leg extension (16) having a first end (16-A) and a second end (16-B). Lower body member includes a second leg extension (18) having a first end (18-A) and a second end (18-B). Lower body member further includes and an upwardly protruding crotch extension (20) having a bottom end (20-A), a top end (20-B), a first side (20-C) and a second side (20-D) with the first side and the second side (20-C & 20-D) being opposed to each other.

The first end (16-A) of the first leg extension (16) is fixedly attached onto the first side (20-C). The first end (18-A) of the second leg extension (18) is fixedly attached onto the second side (20-D).

Referring now to the upper body member that includes a first arm extension (22), a second arm extension (24), a head extension (26), and a central vertical extension (28). The central vertical extension (28) having a first end (28-A), a second end (28-B), a first side (28-C) and a second side (28-D). The first side (28-C) of the central vertical extension (28) being opposed to the second side (28-D) of said central vertical extension (28). The first arm extension (22) is fixedly attached onto the first side (28-C) of the central vertical extension (28). The second arm extension (24) is attached onto the second side (28-D) of the central vertical extension (28) and the head extension (26) is fixedly attached onto the first end (28-A) of the central vertical extension (28). It is to be noted that the head extension (26) includes a face that is either painted or silk-screened thereon.

It is to be noted any suitable type of attachment means of engineering choice for attaching each extension is optional but welding as depicted herein is very cost effective and functional.

As further depicted herein the lower body member and the upper body member are removably attached together by a flexible device. It is to be understood any suitable type of flexible device of engineering choice may be incorporated. However, a resilient spring (30) is most cost effective and functional. The resilient spring (30) includes a downwardly extending protuberance (32) and an upwardly extending protuberance (34) each of which are fixedly attached onto the resilient spring (30) by welding or the like. The downwardly extending protuberance (32) includes a push-button mechanism (36) and the upwardly extending protuberance (34) includes a push-button mechanism (38). The top end (20-B) of upwardly protruding crotch extension (20) includes an internal receptacle (20-E) for slidably receiving the downwardly extending protuberance (32) therein and horizontal holes (42) for slidably receiving push-button mechanism (36). Whereby the lower body member is removably adjustably attached onto the flexible device. The second end (28-B) of the central vertical extension (28) includes an internal receptacle (28-E) for slidably receiving the upwardly extending protuberance (34) therein and horizontal holes (44) for slidably receiving push-button mechanism (38). Whereby the lower body member is removably adjustably attached onto the flexible device. Whereby the upper body member is removably adjustably attached onto the flexible device. Therefore, as a result the framework is adjustable and thus variable in height.

Referring now to the attachment means for removably attaching the first foot member (12) onto the lower body member. Whereby the first foot member (12) includes an internal cavity (46) that is of a shape and size to frictionally receive and retain therein the second end (16-B) of the first leg extension (16). Referring now to the attachment means for removably attaching the second foot member (14) onto the lower body member. Whereby the second foot member (16) includes an internal cavity (48) that is of a shape and size to frictionally receive and retain therein the second end (18-B) of the first leg extension (18). Whereby foot members (12 & 14) are each removably attached onto the lower body member and function in combination as suitable support means. It is to be noted that as an option the internal cavities (46 & 48) maybe angled (not shown) whereby each leg extension (16 & 18) do not need to be bent or require an additional portion welded thereon as depicted herein. Thus, each leg extension maybe easily directly inserted. It is to be noted each foot member maybe formed from one solid unit having the noted internal cavities (46 & 48). However, another option for construction of each foot member (12 & 14) is to include variable weight means such as a variable weight substance including sand or fluid, etc. For example, each foot member (12 & 14) may include a second internal cavity (47 & 49) each of which are in open communication with a fill hole (51 & 53) and each fill hole includes removable closure means, such as plugs (55 & 57). Whereby resulting in each cavity (47 & 49) being fill able with the noted variable weight substance. It is to be further noted each foot member maybe shaped into a novel form, for example each foot member may resemble a clown shoe (not shown) or the like, so as to be comical and amusing to the viewer.

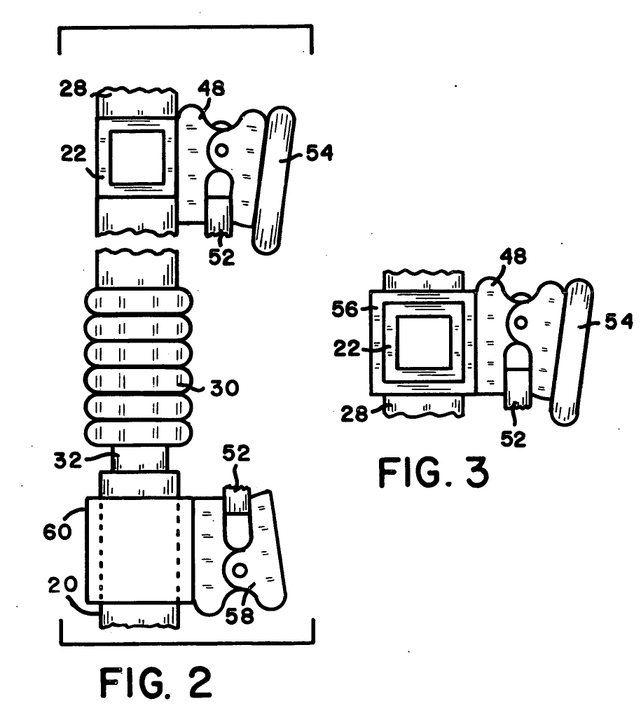

Referring now to the attachment means on the framework for removably attaching a display sign thereon as depicted in FIGS. 1 and 2. The attachment means including in combination a first clamp (48) and a second clamp (50) the second clamp is only shown in FIG. 1. First clamp (48) includes a fixedly attached plate (54) in the shape of a human hand, and the second clamp (50) includes a fixedly attached plate (58) (only shown in FIG. 1) in the shape of a human hand resulting in a novel visual effect of the display sign (52) being held by a pair of hands, respectively.

It is to be noted each clamp (48 & 50) maybe fixedly attached onto each arm extension (22 & 24) of the framework by welding. However, if preferred each clamp (48 & 50) maybe slidably engaged onto the framework as depicted in FIG. 3. Wherein each clamp (48 & 50) are fixedly attached onto an attachment member (56) (only one shown but two are inherent) that is/are of a shape and size to be slidably engaged onto each arm extension (22 & 24). Whereby, resulting in the distance between each clamp (48 & 50) being adjustable thus providing support for advertising signs of various sizes including various widths.

The attachment means on the framework for removably attaching a display sign thereon further includes a third clamp (58) that is fixedly attached onto a third clamp support member (60) that is slidably engaged onto the framework, thus providing adjustment means for support of advertising signs of various sizes including various heights. It is to be noted the third clamp support member (60) maybe slidably engaged onto either the second end (28-B) of the central vertical extension (28) or onto the top end (20-B) of upwardly protruding crotch extension (20). This is dependent upon the length of each extension (28 & 20) as determined by engineering choice and/or the size of the advertising sign of user choice. Also, the third clamp (58) may have a belt buckle displayed thereon.

It is to be noted that if so desired the framework may include locking means for securing the framework onto the ground surface so as to eliminate possible theft thereof. Although the locking means is not shown it is to be inherent within the overall scope of the invention.

It can now be seen we have herein provided a new and novel support stand for display of an advertising sign. The support stand is formed into a “stick-type” framework that resembles a human form. The support stand is unique as it moves when subjected to air turbulence caused by wind that in turn moves the sign similar to the movements of a human. Also, the components are portable, easily assembled, are cost-effective to produce and the support stand is comical or amusing when viewed. Although the invention has been herein shown and described in what is conceived to be the most practical and preferred embodiment, it is recognized that departures may be made there from within the scope and spirit of the invention, which is not to be limited t6 the details disclosed herein but is to be accorded the full scope of the claims so as to embrace any and all equivalent devices and apparatuses.

Having described the invention, what I claim as new and desire to secure by Letters Patent is:

1. A human shaped portable, moving support stand for display of an advertising sign: comprising: in combination a stick framework that resembles a human form; attachment means on said framework for removably attaching a display sign thereon; support means for supporting said stick framework in an upright standing position; and a flexible device that flexes when subjected to air turbulence caused by wind thus resulting in movement of said stick framework.

2. The human shaped portable, moving support stand for display of an advertising sign of claim 1 wherein said stick framework is formed from body members that are removably attached together.

3. The human shaped portable, moving support stand for display of an advertising sign of claim 2 wherein said body members comprising: a first foot member; a second foot member; a lower body member; an upper body member; and each said foot member in combination provide said support means.

4. The human shaped portable, moving support stand for display of an advertising sign of claim 3 wherein said first foot member includes attachment means for removably attaching said first foot member onto said lower body member, said second foot member includes attachment means for removably attaching said second foot member onto said lower body member, said lower body member and said upper body member being removably attached together by said flexible device, said lower body member includes a first leg extension having a first end and a second end; a second leg extension having a first end and a second end; and an upwardly protruding crotch extension having a bottom end, a top end, a first side and a second side with said first side and said second side being opposed to each other, said first end of said first leg extension being fixedly attached onto said first side, said first end of said second leg extension being fixedly attached onto said second side, said upper body member includes a first arm extension; a second arm extension; a head extension; and a central vertical extension having a first end, a second end, a first side and a second side, said first side of said central vertical extension being opposed to said second side of said central vertical extension, said first arm extension being fixedly attached onto said first side of said central vertical extension, said second arm extension being attached onto said second side of said central vertical extension, and said head extension being fixedly attached onto said first end of said central vertical extension.

5. The human shaped portable, moving support stand for display of an advertising sign of claim 4 wherein each said extension are fixedly attached by welding.

6. The human shaped portable, moving support stand for display of an advertising sign of claim 4 wherein said attachment means for removably attaching said first foot member onto said lower body member includes said first foot member having an internal cavity that is of a shape and size to frictionally receive and retain therein said second end of said first leg extension, said attachment means for removably attaching said second foot member onto said lower body member includes said second foot member having an internal cavity that is of a shape and size to frictionally receive and retain therein said second end of said second leg extension.

7. The human shaped portable, moving support stand for display of an advertising sign of claim 1 wherein said attachment means on said framework for removably attaching a display sign thereon comprising: in combination a first clamp; and a second clamp.

8. The human shaped portable, moving support stand for display of an advertising sign of claim 7 wherein each said clamp is fixedly attached onto said framework.

9. The human shaped portable, moving support stand for display of an advertising sign of claim 7 wherein said first clamp includes a fixedly attached plate in the shape of a human hand, and said second clamp includes a fixedly attached plate in the shape of a human hand resulting in a novel visual effect of said display sign being held by a pair of hands.

10. The human shaped portable, moving support stand for display of an advertising sign of claim 7 wherein each said clamp is slidably engaged onto said framework thus resulting in the distance between each said clamp being adjustable for support of advertising signs of various sizes.

11. The human shaped portable, moving support stand for display of an advertising sign of claim 7 further includes a third clamp, said third clamp being fixedly attached onto a support member and said support member being slidably engaged onto said framework, thus providing adjustment means for support of advertising signs of various sizes.

12. The human shaped portable, moving support stand for display of an advertising sign of claim 3 wherein each said foot member further includes variable weight means.

13. The human shaped portable, moving support stand for display of an advertising sign of claim 12 wherein said variable weight means comprising: each said foot member having a second internal cavity, said internal cavity being in open communication with a fill hole, and said fill hole having removable closure means thus resulting in said cavity being fill able with a variable weight substance.

14. The human shaped portable, moving support stand for display of an advertising sign of claim 1 wherein said framework is made from square tubing.

15. The human shaped portable, moving support stand for display of an advertising sign of claim 4 wherein said lower body member and said upper body member being removably attached together by said flexible device further includes said flexible device having height adjustment means for varying the height of said framework.
